(19) United States
(12) Patent Application Publication
(10) Pub. No.: US 2009/0229528 A1
(43) Pub. Date: Sep. 17, 2009

(54) Pet food dish with ant barrier

(76) Inventor: James Carl McMurtry, Lawndale, CA (US)

Correspondence Address: Robert M. Ashen, 1737 Franklin Canyon Drive, Beverly Hills, CA, 90210, US

(21) Appl. No.: 12/075,502

(22) Filed: Mar. 12, 2008

(51) Int. Cl. A01K 5/01; A01K 5/00

(52) U.S. Cl. 119/61.53

(57) ABSTRACT

A pet food dish formed to protect the contents of the dish from ants. The illustrated dish has an upwardly open central portion for holding a quantity of pet food and allowing the pet access to the food. In one embodiment, the dish has a peripheral portion that is connected to and extends completely around the central food-holding portion. The peripheral portion forms a seal with the central portion and defines an upwardly open, liquid-holding trough that extends completely around the periphery of the dish. When the trough is filled with water or other liquid, it provides a moat or liquid barrier that prevents ants reaching the food in the dish. The trough may be manufactured as part of the dish, or it may be provided as an add-on attachment member to be removably assembled by the user with a standard dish. In another embodiment, a two-member dish device comprises a separate dish member, a separate moat-providing base member, and inter-engaging means on said members to limit relative movement between them.

### FIELD OF THE INVENTION

Pet food dishes which include a barrier for protecting the contents of the dishes from being reached by ants.

### BACKGROUND

There is an unfilled need for apparatus and method that will adequately protect pet food in an open pet food dish from ants.

### The Problem

The problem is ants. Ants get into the pet food dish. Always prevalent outdoors, they easily find a pet food dish placed outside; but since they can enter just about any house, they oftentimes find the pet dish indoors too. When an explorer ant discovers a food source, he identifies it as food by physically inspecting it. He must, however, inspect the food by touching it. Then, from the point of the food source, he lays down an odor trail all the way back to the chamber of his waiting colony. Thus alerted, the colony swarms forth upon the explorer-ant's chemical trail. But if the explorer ant is unable to actually reach the food itself, he will lay down no odor trail and no ants will be directed to the food; accordingly, no ant swarm will appear in and around the dish.

Ants come in a variety of species. Ant poisons kill some of these but are ineffectual against others, and hence, unreliable. Additionally, no one ever knows how long ant killers will retain their potency; very often the only real indicator is the next big ant swarm. Moreover, people don't want poisons inside their residence where children or pets might be endangered by contact with them.

### The Solution

The types of ants commonly considered household pests in the United States and elsewhere will not cross a barrier of water. The function of the illustrated pet food dishes is to deny any explorer ant access to the pet food in the dishes by means of a water barrier or water filled “moat” around the circumference of the dishes. This moat may be created in various ways including the following three. In a first configuration, the moat is provided around the bottom or side of the dish. In a second configuration, the moat can be a separate part, such as a ring shaped trough which is placed around a standard pet bowl; the ring is easily accommodated by the standard tapered dish which is narrower at the top. In a third configuration, the separate food dish may be placed in a separate saucer-like pond member with which it inter-engages to limit transverse relative movement. These configurations all create a “no-ant” moat around the pet food dish to keep ants out.

Explorer ants will stop short at a water-filled moat. Since they cannot cross it, they will not summon a swarming ant colony to invade the food dish.

Convenience is part of the solution. Such a moat dish an any configuration is easy to fill with water and to empty. A water-moat of about thumb-width is easy to clean. A roughly equivalent water depth will prevent the water from evaporating away too quickly.

### SUMMARY OF THE DISCLOSURE

The drawings show several (i) pet food dishes with peripheral liquid barriers, and (ii) separate liquid-barrier-providing attachments for standard pet food dishes, that provide presently preferred embodiments of the invention.

One illustrated pet food dish is in the form of a bowl has a peripheral barrier in the form of a trough or channel that extends completely around the bowl. When the trough is filled with liquid such as water, the resulting liquid barrier is sufficiently wide and deep to prevent ants from reaching the contents of the bowl. The illustrated bowl has a bottom wall and upstanding side walls that define a central receptacle for holding a portion of pet food. . The illustrated peripheral trough is connected to the side wall so that there are on no openings or spaces between them through which ants might proceed. In one form, the trough may be formed by an extension of the lower edge of the side walls being turned upwardly. In another form, the trough may be formed by an extension of the upper edge of the side walls being turned first downwardly and then upwardly. In another form, the dish may take the form of a generally flat plate. Another presently preferred embodiment of the invention is a separate, trough-forming attachment that is attachable to a standard pet food bowl.

The bowl may be constructed of any suitable material such as plastic, metal, rubber or the like. The bowl may be a single unitary piece of material formed into the desired shape. Plastic and rubber-type material could be formed by known molding processes. Metal could be formed by known stamping or other metal forming methods. Alternatively the bowl could be fabricated from multiple sections that are secured to one another as by a variety of known securing means such as nuts and bolts, adhesive, welding, heat fusion, etc.( to some extent determined by the material of the sections). In particular, the trough-forming portion may be a separate section and may be of a different material from the rest of the bowl, such as a high-friction non-skid material.

While the illustrated pet food dish is designed particularly to protect the pet food from ants, it will also serve to separate and protect the food in the dish from other small insects that will not be able to cross the water filled trough.

### IN THE DRAWINGS:

FIG. 1 is a schematic top plan view of a pet food dish which is a presently preferred embodiment of the invention.

FIG. 2 is a schematic side sectional view of the dish of FIG. 1.

FIG. 3 is a schematic side sectional view of a modified form of pet food dish.

FIG. 4 is a schematic top plan view of a different shape dish..

FIG. 5 is a schematic top plan view of an oval shape dish.

FIG. 6 is a schematic side sectional view of a modified form of dish fabricated from multiple sections.

FIG. 7 is a schematic side sectional view of a modified dish having a trough that is V-shaped in cross-section

FIG. 8 is a schematic side sectional view of a modified dish having a trough that is rectangular in cross-section.

FIG. 9 is a schematic side sectional view of a separate trough-forming attachment about to be mounted upon a standard pet food dish.

FIG. 10 is a schematic side sectional view of the attachment of FIG. 9 shown mounted upon the standard pet food dish.

FIG. 11 is a schematic side sectional view of an attachment and dish similar to that shown in FIGS. 9 and 10, with the addition of a sealing member.

FIG. 12 is a schematic top plan view of a barrier providing attachment and a dish similar to that of FIGS. 9 and 10, where the attachment and the dish are generally rectangular.

FIG. 13 is a schematic side sectional view of a pet food dish which is another presently preferred embodiment of the invention.

FIG. 14 is a schematic side sectional view of a low profile pet food dish which is another preferred embodiment of the invention.

FIG. 15 is a schematic side sectional view of a two-member pet food dish which is another preferred embodiment of the invention, comprising a separate bowl inter-engaged with a large moat providing base.

FIG. 16 is similar to FIG. 15, showing a different means for inter-engaging the bowl and the base.

### DETAILED DESCRIPTION OF THE DRAWINGS

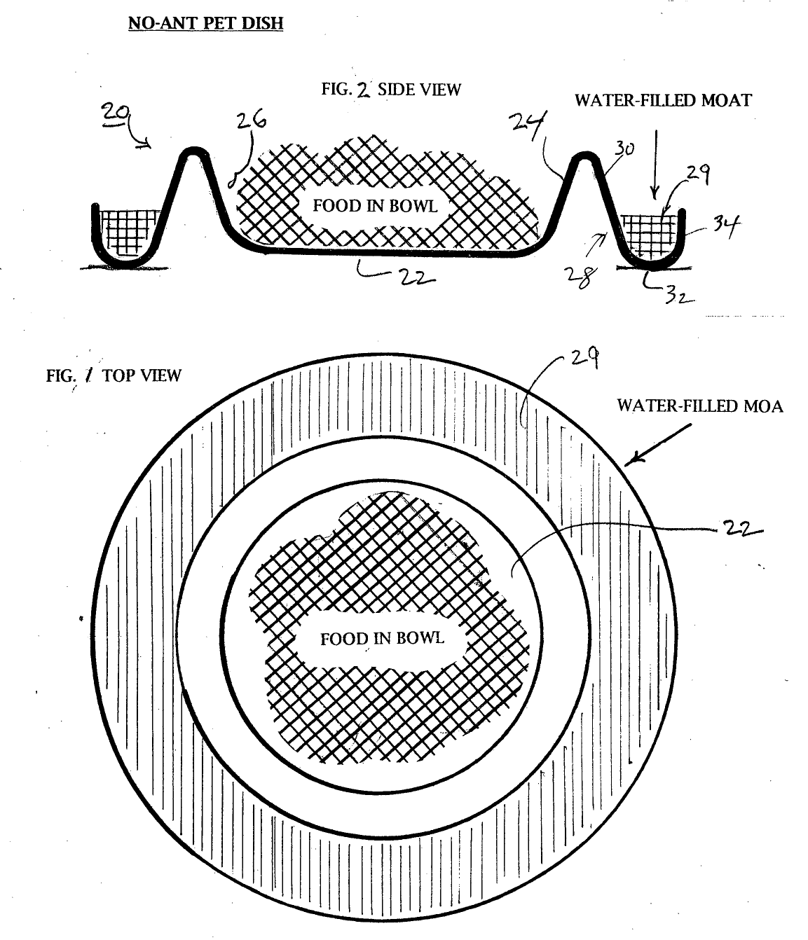

FIGS. 1 and 2 illustrate a pet food dish 20 which is a presently preferred embodiment of the invention. The illustrated dish 20 is in the form of a bowl that includes a generally circular bottom wall 22 and generally up right sidewalls 24. The bottom wall 22 in the sidewalls 24 define a receptacle 26 for a portion of pet food.

Connected to the side walls 24 and extending completely around the bowl is an outer peripheral portion 28 that defines an upwardly open channel or trough 29. The trough 29 may be filled with water or other liquid to define an ant stopping water barrier or moat 31 that extends completely around the bowl 20. More particularly, the illustrated outer peripheral trough 28 includes a generally upright inner trough wall 30 that is secured along its upper edge to the upper edge of the side walls 24. The lower edge of the inner trough wall 30 is connected to a curved bottom trough wall 32 that in turn is connected to the lower edge of a generally upright outer trough wall 34. The trough walls 30, 32 and 34 define the moat. 29. The trough 29 is sufficiently wide and deep to prevent ants from crossing it to reach the food holding receptacle 26 of the bowl.

Good results have been achieved with a trough having a generally semi-circular cross section with a radius of about one-half inch. This provides a water-filled moat about one inch across, with a maximum depth of about one-half inch. This provides an adequate barrier to ants. It also lends itself to be easily cleaned with a finger of the user. The size of the moat may vary somewhat. For example, the moat may be about one and one-half inches across, particularly for a larger dish.

As shown best in FIG. 2, the bottom trough wall 32 of the bowl 20 supports the bowl on a surface such as a patio, deck or lawn.

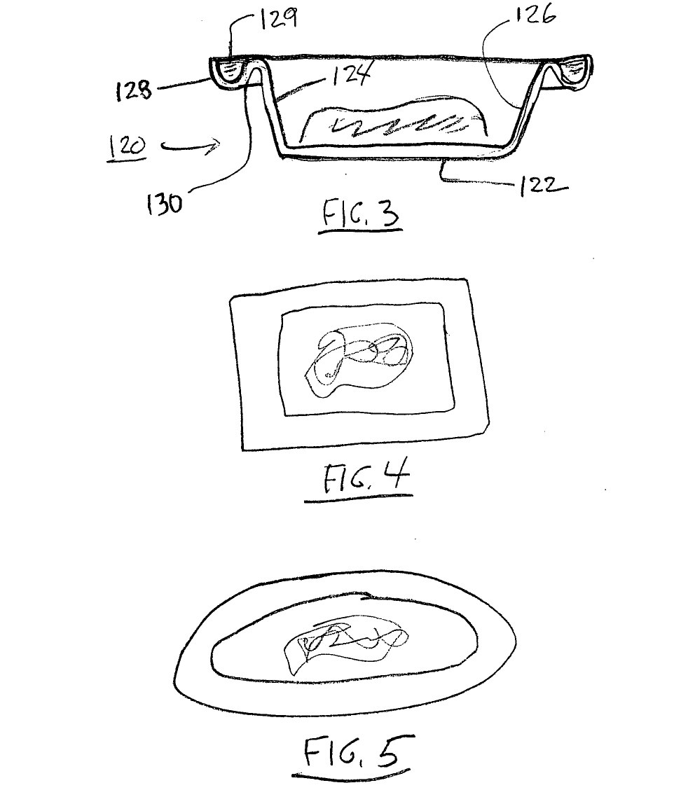

FIG. 3 illustrates a slightly modified bowl 120 where the peripheral outer trough portion 128 has a short upright inner trough wall 130 which causes the trough 129 to be elevated and located adjacent to the upper edge of the side walls 124. The bowl 120 rests upon its bottom wall 122..

The pet food dish may take various different shapes. For example, it may be rectangular as shown in FIG. 4 or generally oval as shown in FIG. 5.

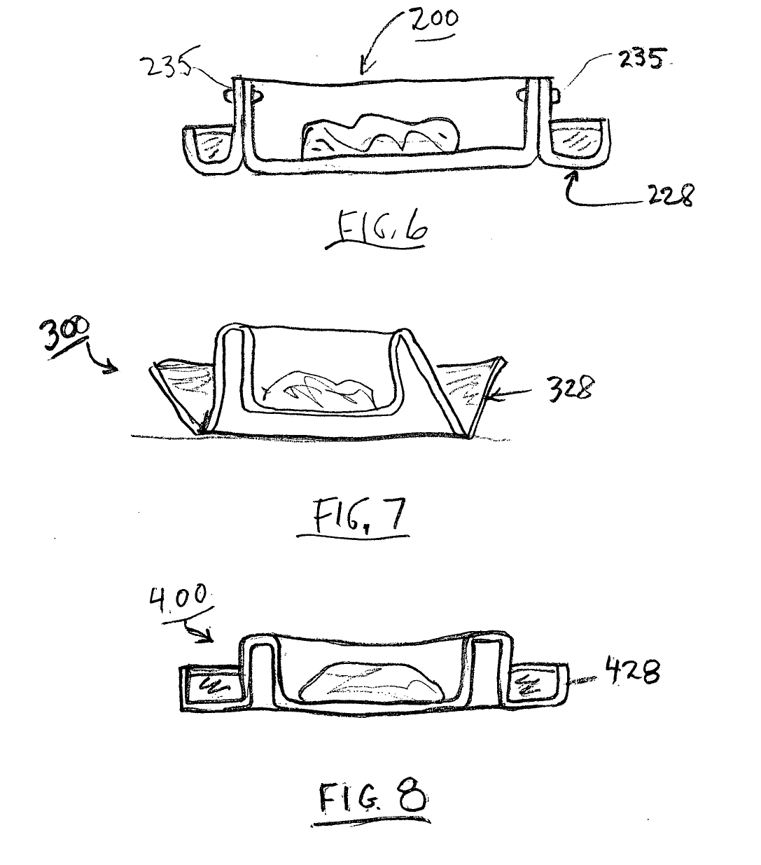

The bowl 20 of FIG. 1 and 2 is shown as a single piece of material formed to provide the food receiving receptacle 26 and the peripheral trough-forming portion 28. This has several advantages such as ease and economy of manufacture/fabrication and upkeep. Cleaning is easy and facilitated. However, alternative constructions may be utilized. For example, the trough-forming peripheral outer portion may be provided by a separate section. This is illustrated in FIG. 6 which shows a modified dish in the form of a bowl 200 having a separate peripheral outer trough-defining portion 228 that is fixedly connected to the bowl sidewalls 224 by suitable connecting means such as nuts and bolts 235. The portion 228 might be made of a higher-friction non-skid material to keep the dish from moving around too much while the pet is eating out of it. Similarly, the illustrated trough 29 has a generally curved bottom provided by the curved bottom trough wall 32.. This is a desirable configuration in terms of both manufacturer and maintenance of the bowl. It lends itself to be easily and completely cleaned. However, other trough shapes might be utilized. FIG. 7 illustrates a V-shaped cross-section for the trough-defining peripheral outer portion 328, while FIG. 8 illustrates a rectangular shape cross-section for the trough defining outer portion 428.

FIGS. 9 and 10 illustrate a separate, trough-providing attachment 1000 for being removably mounted upon a standard pet food dish in the form of bowl B. This bowl B has generally upright sidewalls 1024 that are sloped or inclined slightly outwardly from top to bottom. The illustrated attachment 1000 is in the form of a closed ring or loop that defines a liquid-holding trough or channel forming portion 1028. The attachment 1000 is shown in FIG. 9, elevated above the standard pet food bowl B in a position to be lowered onto the bowl. FIG. 10 shows the attachment 1000 after it has been lowered onto the bowl and is supported by the angled sidewalls 1024 of the bowl. The angle of the sidewalls 1024 creates a wedged inter-engagement between the attachment 1000 and the sidewalls 1024. This wedged inter-engagement will tend to create a seal that serves to block passage of any ants up the outside of the sidewalls 1024 beyond the location of the attachment 1000. Any ants crawling around the trough-forming portion 1028 will encounter the water filled trough and will thereby be stopped from further movement toward the food in the receptacle 1026. The attachment 1000 may be removed from the bowl B for cleaning of attachment and /or bowl, for storing the attachment, etc.

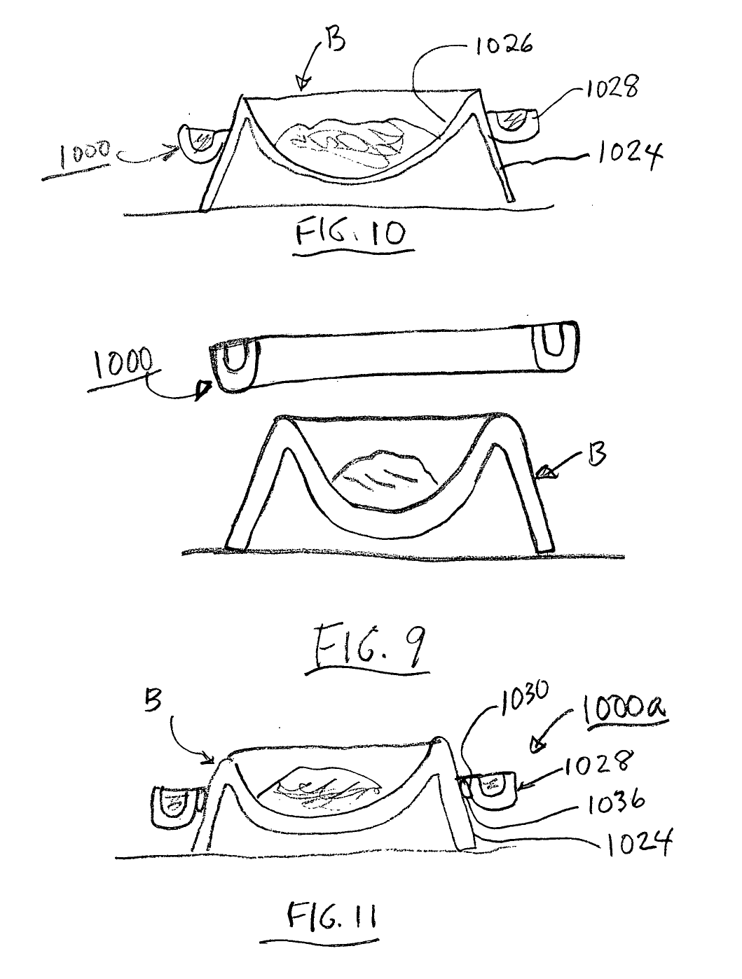

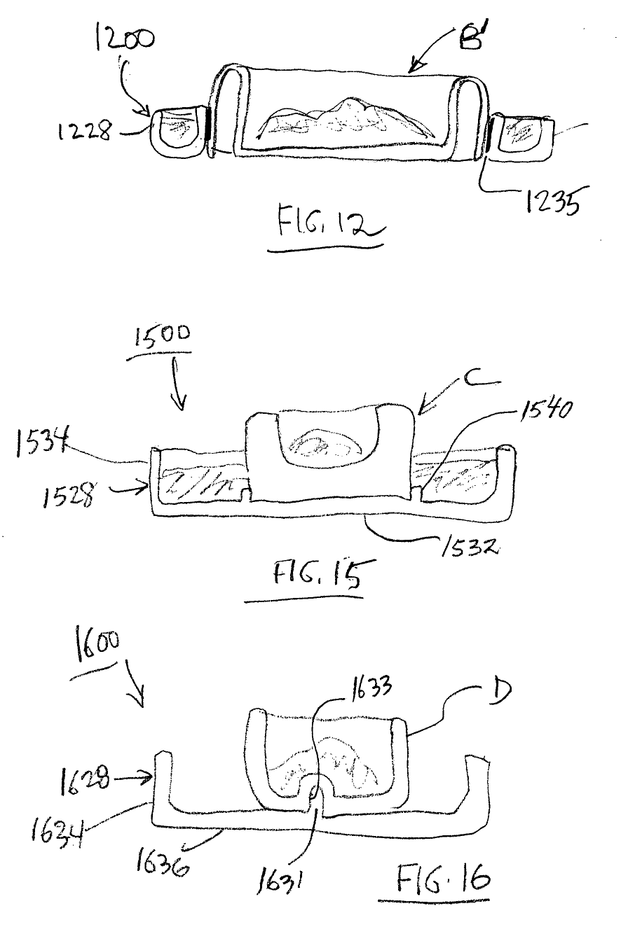

FIG. 11 illustrates a modified attachment 1000A which includes and annular sealing member or element 1036 disposed between the outer surface of the sidewalls 1024 and the inner trough wall 1030 of the trough-forming portion 1028. This sealing element 1036 may be made of a hard but somewhat compliant material such as a rubber O-ring, or it may be made of a softer material such as foam rubber or foam plastic. Such a sealing element 1036 tends to ensure the integrity and completeness of the seal between the engaging surfaces of the sidewalls and the attachment 1000A, regardless of any irregularities in those surfaces themselves or in their interface.

FIG. 12 illustrates an attachment 1200 that may be permanently affixed to another shape standard pet food dish B′ by various known connecting means. FIG. 12 illustrates the use of an adhesive layer 1235. Some may find this arrangement more desirable as the attachment will not be misplaced or lost.

FIG. 13 illustrates a modified form of trough-providing attachment 1300 that is similar to attachment 1000 except that it is rectangular instead of circular, for attachment to a rectangularly shaped dish..

Having a separate trough-providing attachment has several advantages. A single attachment can be used for several different pet food bowls at different locations and of somewhat different sizes. It will be noted that the larger the size of the bowl, the higher up the attachment will seat itself on the inclined sidewalls. Further, the attachment may be cleaned separately. It may be stored when not needed, as when the bowl is used within the home where there are no ants present. Still further, the attachment is less costly than a complete bowl including a trough- providing portion as it requires less material and simpler and less costly manufacture/fabrication.

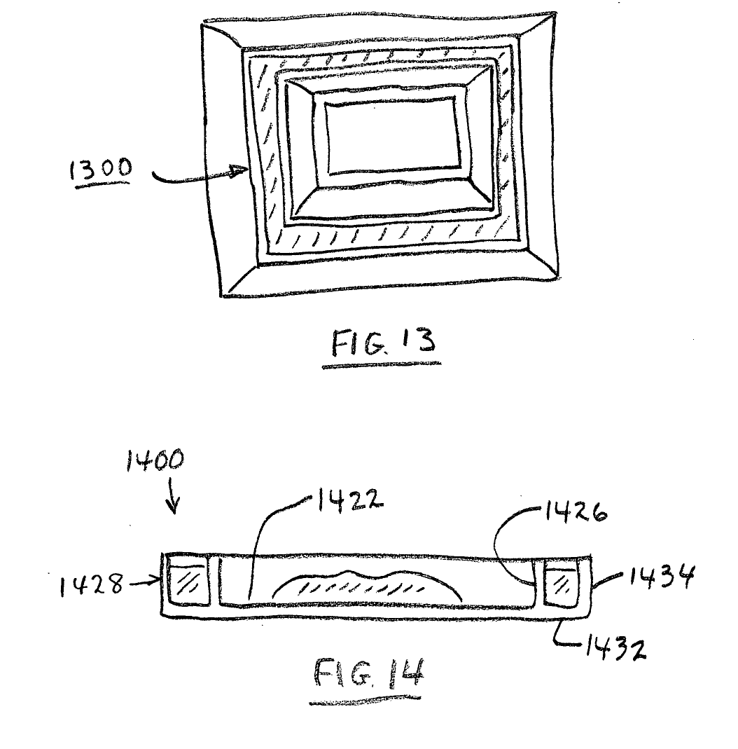

FIG. 14 illustrates another presently preferred embodiment in the form of a low-profile dish 1400. This dish 1400 has a bottom wall 1422. The plate 1400 shares a generally vertical peripheral side wall 1426 with an outer trough-forming portion 1428. That outer portion 1428 also has a generally flat trough bottom wall 1432 and a generally vertical trough outer wall 1434.

FIG. 15 illustrates a two-member dish device 1500 that is another presently preferred embodiment. Dish device 1500 has a separated base member 1527 that provides the moat 1528. The base member 1527 has a large bottom wall 1532 and a generally upright outer side wall 1534. The dish device 1500 also has a separate bowl member C that rests upon the bottom wall 1532 and inter-engages with the bottom wall 1532 to limit transverse movement of the bowl member relative to the bottom wall. In the dish device 1500 the inter-engagement is achieved by a circular retainer rim or lip 1540 that extends upwardly from the upper surface of the bottom wall 1532. The lip 1540 forms a receptacle for the lower end of the dish member C. This configuration allows use of the base member 1527 with a standard pet food dish. Transverse movement need not be completely prevented so long as it is adequately limited.

FIG. 16 shows a modified two-member dish device 1600 similar to dish device 1500 where the interconnection is achieved by an upward protection or pin 1631 on the bottom wall 1632 that is received in a receptacle or recess 1633 in the bottom of the separate dish member C.

Other forms of the interconnection may be used such as a pair of inter-engaging velcro-type strips, one on the base member and one on the dish member

The illustrated devices may be modified in various ways without departing from the spirit and scope of the present invention which is defined by the following claims..

What is claimed:

1. A pet food dish for protecting the contents of the dish from being accessed by ants, said dish comprising:
a central member having an upwardly open food area for receiving a member of pet food and being accessible to a pet,
a trough-forming member connected to and extending completely around the periphery of the central member, said trough-forming member being upwardly open and configured to receive and retain sufficient liquid therein to provide a liquid barrier to ants trying to traverse said trough-forming member to access said open food area.

2. The pet food dish of claim 1 wherein said trough-forming member is integrally formed with said central member.

3. The pet food dish of claim 2 wherein said pet dish is a unitary article formed by molding plastic or rubber-type material

4. The pet food dish of claim 2 wherein said pet dish is a unitary article formed as a single piece of metal.

5. The pet food dish of claim 1 having a generally upright annular side wall

6. The pet food dish of claim 1 wherein said trough-forming member is generally annular and of the same shape as said central member.

7. The pet food dish of claim 1 wherein said trough-forming member has a smoothly curved cross section.

8. The pet food dish of claim 5 wherein said trough-forming member comprises an upwardly extending extension of said side wall.

9. The pet food dish of claim 3 wherein said trough-forming member is an integrally-formed, upwardly extending extension of said central member.

10. A separate, liquid barrier providing attachment for connecting to a standard pet food dish, the dish being upwardly open to allow the pet to access the food in the dish, said attachment comprising:
an element in the form of a closed loop, said element being configured and arranged to (i) engage and form a sealing inter-engagement with the dish around the full periphery of the dish, and (ii) define a trough that extends completely around the dish for receiving and retaining liquid sufficient to provide a liquid-barrier which will prevent ants from traversing such barrier and reaching the pet food in the dish.

11. The attachment of claim 10 wherein said attachment is configured and arranged to be removably attached to the pet food dish.

12. The attachment of claim 10 wherein said attachment is configured and arranged to be permanently attached to the pet food dish.

13. The attachment of claim 10 further including an annular flexible seal disposed between the inter-engaging surfaces of said attachment and the pet food dish to ensure closure of any openings that might exist between such surfaces so as to prevent passage of ants between said surfaces.

14. The attachment of claim 10 wherein the pet food dish has a generally upright annular sidewall that has an outward surface that is generally vertical but inclined outwardly from top to bottom of said wall, set attachment being a generally annular ring configured, promembered and arranged to fit over said annular sidewall and to engage that sidewall in a wedge like engagement so as to support said attachment and to form a seal between the attachment and the sidewall that extends completely around said the sidewall.

16. A method for protecting pet food on a pet dish from being reached by ants, said method comprising providing a body of liquid completely around the periphery of the pet dish so as to form a liquid barrier separating the food on the pet dish from ants attempting to reach the food from the environment around the dish, said liquid barrier being sufficiently wide and deep to prevent ants from traversing the barrier to reach the pet food.

17. A two-member pet food dish device for limiting ants access to the food in the dish, said dish device comprising:
1. a separate dish member for holding pet food, said dish member being open at the top so that the food can be accessed by the pet,
2. a separate base member for supporting the dish member, said base member having a base bottom wall and a generally upright base outer wall that define a receptacle for a body of liquid, and
3. inter-engaging means on said dish member and on said base member for inter-engaging to limit relative transverse movement between said members.

18. The dish device of claim 17 wherein said inter-engaging means is in the form of an annular rib that extends upwardly from said base bottom wall to form a receptacle for receiving the lower end of said dish member.

19. The dish device of claim 17 wherein said inter-engaging means is in the form of a projection on one of said members and a mating recess on the other of said members for receiving said projection.

20. The dish device of claim 17 wherein said inter-engaging means is in the form of a pair of releasibly inter-engaging velcro-type strips, each on one of said members.

21. The dish of claim 1 wherein said trough-forming member has an upwardly open upper end that has a width of about one-inch.
